(19) United States
(12) Patent Application Publication
(10) Pub. No.: US 2005/0052083 A1
(43) Pub. Date: Mar. 10, 2005

(54) Method for identifying faulty antivalent key or switch signals

(75) Inventor: Ronald Hauf, Mohrendorf (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/935,542

(22) Filed: Sep. 7, 2004

(30) Foreign Application Priority Data
Sep. 8, 2003 (DE) 103 41 324.3

(51) Int. Cl. B60L 3/00

(52) U.S. Cl. 307/10.1

(57) ABSTRACT

A method for identifying of faulty antivalent key or switch signals of an antivalent key or switch of a control unit is described. Two antivalent signals are outputted by the key or switch, whereby the two outputted signals are recognized as being faulty if the two signals have the same logical state. In this way, faulty antivalent key or switch signals can be ready be detected. The method can also detect brief inadvertent interruptions in the signals and short circuits and ground faults. The method can be used in particular with control units used to control machine tools and production machines.

### CROSS-REFERENCES TO RELATED APPLICATIONS

This application claims the priority of German Patent Application, Serial No. 103 41 324.2, filed Sep. 8, 2003, pursuant to 35 U.S.C. 119(a)-(d), the disclosure of which is incorporated herein by reference.

### BACKGROUND OF THE INVENTION

The present invention relates to a method for identifying faulty antivalent key or switch signals from an adtivalent key or switch of a control unit.

Nothing in the following discussion of the state of the art is to be construed as an admission of prior art.

In many technical fields, for example, in applications using machine tools and production machines, control units are typically equipped with keys or switches that close or open two contacts simultaneously upon actuation, so as to ensure that safety-related functions operate properly.

FIG. 1 shows a commercially available double-make key 1 that can be installed in a control unit for controlling safety-relevant functions. The two contacts 5 and 6 are closed at the same time when the key 7 is pressed. After the contacts are closed, the signals 2 and 3 have a high potential corresponding to an applied voltage U. The logical signal state (low level or high level) is monitored by an evaluation unit 4. If a fault is not detected, then the two signals 2 and 3 have always the same logical signal state, i.e., both signals have either a high level or a low level. However, if the evaluation unit 4 detects that the signals 2 and 3 are faulty, i.e., have a different logical state, then the evaluation unit 4 generates an error signal 12, which depending on the actual application is either used to indicate the fault, with the safety-relevant functions nevertheless being activated (e.g., switch off a drive), or the error signal 12 is used to block a control command (e.g., switch on a drive). Since the two contacts 5 and 6 are closed when the key 7 is pressed, such key is also referred to as a double-make combination. This method for evaluating the switch state in the evaluation unit 4 has a significant disadvantage in that a double-fault is not detected. For example, a double-fault can occur when signal 2 and signal 3 are interrupted due to, for example, a break in a wire. Other possibilities for double-faults are, for example, a short circuit between the two signal lines or simultaneous ground faults of the two signal lines. It will be understood that a switch provided with a double-make contact combination can also be used instead of the key 1.

FIG. 2 shows another type of a commercially available double-break contact key 1′ that can be installed in a control unit for controlling safety-relevant functions. The two contacts 8 and 11 are opened at the same time when the key 7′ is pressed. After the contacts are opened, the signals 2 and 3 have a low potential. The logical signal state (low level or high level) is monitored by an evaluation unit 4. If a fault is not detected, then the two signals 2 and 3 have always the same logical signal state, i.e., both signals have either a high level or a low level. However, if the evaluation unit 4 detects that the signals 2 and 3 are faulty, i.e., have a different logical state, then the evaluation unit 4 generates an error signal 12, which depending on the actual application is either used to indicate the fault, with the safety-relevant functions nevertheless being activated (e.g., switch off drive), or the error signal 12 is used to block a control command (e.g., switch on drive). Since the two contacts 5 and 6 are opened when the key 7′ is pressed, such key is also referred to as a double-break contact combination. Disadvantageously, this method for evaluating the switch state in the evaluation unit 4 is also unable to detect a double-fault. For example, a double-fault can occur when signal 2 and signal 3 are interrupted due to, for example, a break in a wire. Other possibilities for tool faults are, for example, a short circuit between the two signal lines or simultaneous ground faults of the two signal lines. It will be understood that a switch provided with a double-break contact combination can also be used instead of the key 1′.

It would therefore be desirable and advantageous to provide an improved method for identifying faulty antivalent key or switch signals, which obviates prior art shortcomings and is specifically unaffected by wire beaks and ground faults.

### SUMMARY OF THE INVENTION

According to one aspect of the present invention, in a method for identifying faulty key or switch signals from an antivalent key or switch of a control unit, the key or -switch outputs two antivalent signals and the two outputted signals are identified as being faulty if both signals have the same logical state.

Advantageously, the method of the invention can readily identify double-faults. In addition, keys or switches with a double-make contact combination or a double-break contact combination need no longer be installed in a control unit, and a single antivalent key or switch type can typically be used instead. Antivalent switches and keys refer hereby to switches and keys that perform an EXCLUSIVE-OR operation.

According to an advantageous embodiment of the invention, the two signals are recognized as being faulty if both signals have the same logical state during a predetermined period of time. In this way, brief inconsistencies between the signals 2 and 3 can be suppressed when the key is pressed or the switch is actuated.

According to yet another advantageous embodiment of the invention, the two signals are recognized as being faulty if both signals are applied longer than a predetermined period of time, after the key or the switch are actuated. In this way, signals resulting from inadvertent or accidental operations, for example, when a tool drops on the key or switch, can be recognized.

According to another aspect of the invention, a control unit includes a controller connected with the control unit and an evaluation unit integrated in the controller. The control unit includes at least one antivalent key or switch that outputs two antivalent signals. The two outputted signals are identified as being faulty if both signals have the same logical state. When the evaluation unit is integrated in the control unit, no additional hardware is required for the evaluation unit.

According to yet another aspect of the invention, a control unit includes an integrated evaluation unit and at least one antivalent key or switch that outputs two antivalent signals. The two outputted signals are identified as being faulty if both signals have the same logical state. By incorporating the evaluation unit as an integral component of the control unit obviates the need for additional hardware or software extensions outside the evaluation unit.

According to still another aspect of the invention, a machine tool or production machine includes a control unit that includes a controller connected with the control unit and an evaluation unit integrated in the controller. The control unit includes at least one antivalent key or switch that outputs two antivalent signals. The two outputted signals are identified as being faulty if both signals have the same logical state. The operation of machine tools and production machines requires particularly stringent safety measures. However, it should be noted that the invention can be employed in many other technical areas where safety-relevant functions are required in the operation, for example industrial facilities, shipbuilding, submarines, vehicles, spacecrafts, airplanes, railroads, and other control applications.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a commercially available double-make contact switch;

FIG. 2 shows a commercially available double-break contact switch;

FIG. 3 shows an antivalent switch with an evaluation unit connected thereto, embodying the subject matter of the present invention; and

FIG. 4 shows a control unit with a controller connected thereto.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

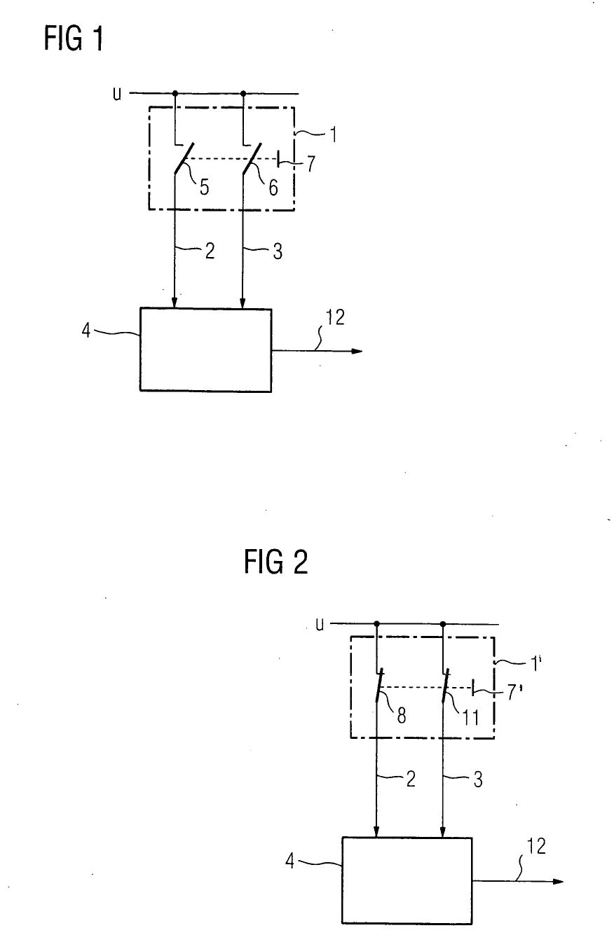

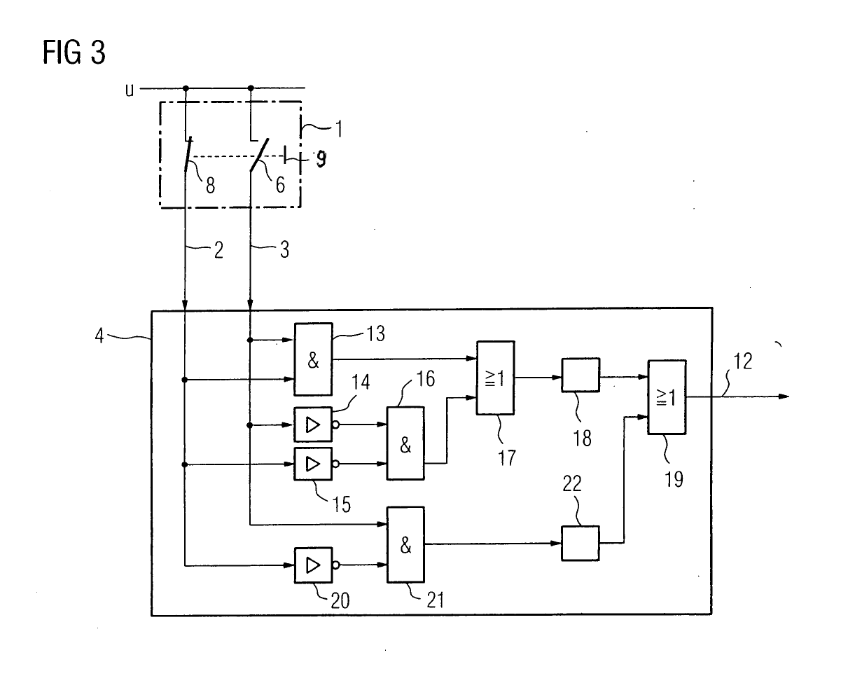

Turning now to the drawing, and in particular to FIG. 3, there is shown an antivalent key 9 and an evaluation unit 4 that performs the method of the invention. It will be understood that an antivalent switch can also be employed instead of the depicted antivalent key 9. Unlike the double-make or double-break contact keys and switches depicted in FIGS. 1 and 2, which include either a double-break contact combination or a double-make contact combination, an antivalent key has a make-break contact combination, i.e., when the antivalent key 9 is actuated, a contact 8 is opened at the same time a contact 6 is closed. When the key 9 is released, the contact 8 is closed and the contact 6 is simultaneously opened. In this way, a voltage U is applied either to the signals 2 or to the signal 3, so that the two signals 2 and 3 in a fault-free state have an antivalent logical signal level, i.e., when signal 2 has a logical high level, signal 3 has a logical low level, and conversely, when signal 2 has a logical low level, signal 3 has a logical high level. A faulty state is distinguished in that the two signals 2 and 3 have an identical logical signal level, i.e., the two signals have simultaneous either a logical low level or a logical high level. With this method for identifying faulty antivalent key or switch signals, double-faults can now advantageously also be recognized. For example, if the signal lines of the signals 2 and 3 have simultaneously short-circuits against ground, short-circuits between them, or simultaneous short-circuits against the supply voltage U, then such faults can be reliably detected by the method of the invention.

Single faults, such as a short-circuit of one of the two signal lines of the signals 2 and 3 against ground, are either immediately detected or are detected after the key 9 is pressed.

The functional components and the corresponding circuits required for the method are indicated in the exemplary evaluation unit 4 depicted in FIG. 3. It will be understood that the method of the invention can also be performed with other functional components and other types of connections. If the two signals 2 and 3 have a logical high level, then the output of the logical functional AND-gate 13, which logically combines the two signals, assumes a high level. As a result, the output of the functional OR-gate 17, which implements a logical OR-function, also assumes a high level. The output signal of the functional OR-gate 17 is supplied to a turn-on delay circuit 18, which after a predetermined period of time also supplies a high level signal. This signal is supplied to a functional OR-gate 19, whose output then also transitions to a high level and thereby generates an error signal 12. The turn-on delay circuit 18, whose output assumes a high level when the input signal has a high level for time period longer than a predetermined time period, is optional. However, the turn-on delay circuit 18 may be desirable for suppressing brief inconsistencies of the signals 2 and 3 when the antivalent key or switch is actuated.

If the two signals 2 and 3 have a logical low level, then the two signals 2 and 3 are inverted in the inverters 14 and 15 to produce a logical high-level at the output of the inverters 14 and 15. The two high level signals applied to the inputs of the functional AND-gate 16 generate at the output of the functional AND-gate 16 a high level signal that is supplied to the functional OR-gate 17. In all other aspects, the evaluation of the signals corresponds essentially to the evaluation described above for the logical high level and will therefore not be discussed in detail.

Faulty key and switch signals may also be generated by inadvertently or accidentally operating the key or switch. Such an inadvertent or accidental operation can occur, for example, when a tool is dropped on the key or switch or by bumping against the key or switch. In many applications, such unintentional actuation of the key or switch has no immediate effect, because the relevant safety function activated with the key or switch may not by immediately interrogated by a control unit of the machine, because the corresponding safety function is not relevant for the current process or machining operation.

Such fault can also be detected by a suitable extension of the method. The method of the invention then checks how long the antivalent key or switch remains in the actuated or switched state. In the afore-described embodiment, the signal level 2 assumes a logical low level when the key 9 is pressed, whereas the signal 3 assumes a logical high level. The inverter 20 and the functional AND-gate 21 operate to provide a logical high level as an output signal of the functional AND-gate 21 when the key 9 is pressed. A turn-on delay circuit 22 checks the length of time during which no interruption is detected when the key 9 is pressed. If the logical signal level at the input of the turn-on delay circuit 22 remains unchanged for a predetermined period of time, then the output of the turn-on delay circuit 22 assumes a high level. As a result, the functional OR-gate 19 generates an error signal 12, i.e., the output of the functional OR-gate 19 transitions to a logical high level.

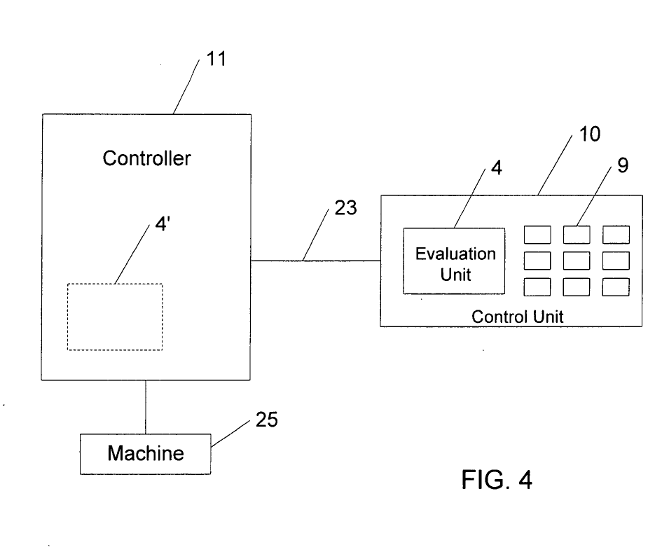

FIG. 4 shows a control unit 10 that is connected via a link 23 for data exchange with a controller 11 that controls a machine 25, for example a machine tool or a production machine. The control unit 10 includes a keypad with antivalent keys 9, only one which labeled for sake of clarity. In the illustrated embodiment, the evaluation unit 4 that executes the method of the invention is an integral component of the control unit 10. Alternatively, the evaluation unit 4′ can also be an integral component of the controller 11, as indicated by the dashed line in FIG. 4. This has the advantage that the logical operations for the method can also be implemented in form of software in a microprocessor system that is already part of the controller 11. It should be noted that a closed loop controller con be used instead of the controller 11.

The control unit can be implemented, for example, in the form of a control panel, a handheld control device, a handheld programming device, an operator console, an operating panel, a Mimic-Board, a cockpit, a control center, and the like.

Machine tools in the context of the present invention can also include, for example, uniaxial or multi-axis lathes, milling machines, as well as drilling or grinding machines. Machine tools can further include processing centers, linear and rotary transfer machines, laser machines, rolling machines and/or gear cutters. These machines have in common that the material is machined along several axes. Production machines in the context of the present invention can include textile, paper, plastic, wood, glass, ceramic or stone processing machines, as well as machines used for forming, packaging, printing, conveying, lifting, pumping, transporting. Furthermore, fans, blowers, wind turbines, lifting gear, cranes, robots, production and assembly lines are also included under the term production machines in the context of the present invention.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for identifying faulty key or switch signals from an antivalent key or switch of a control unit, wherein the key or switch outputs two antivalent signals and the two outputted signals are identified as being faulty if both signals have the same logical state.

2. The method of claim 1, wherein the two signals are recognized as being faulty if both signals have the same logical state during a predetermined period of time.

3. The method of claim 2, wherein the two signals are recognized as being faulty if both signals are applied longer than the predetermined period of time, after the key or the switch are actuated.

4. A control unit comprising a controller connected with the control unit and an evaluation unit integrated in the controller, wherein the control unit includes at least one antivalent key or switch that outputs two antivalent signals and wherein the two outputted signals are identified as being faulty if both signals have the same logical state.

5. A control unit comprising an integrated evaluation unit and at least one antivalent key or switch that outputs two antivalent signals, wherein the two outputted signals are identified as being faulty if both signals have the same logical state.

6. A machine tool or production machine comprising a control unit that includes a controller connected with the control unit and an evaluation unit integrated in the controller, wherein the control unit includes at least one antivalent key or switch that outputs two antivalent signals and wherein the two outputted signals are identified as being faulty if both signals have the same logical state.
